(19) United States
(12) Patent Application Publication
(10) Pub. No.: US 2018/0238374 A1
(43) Pub. Date: Aug. 23, 2018

(54) CLINCH NUT AND METHOD FOR MANUFACTURING ONE SUCH NUT

(71) Applicant: BOLLHOFF OTALU S.A., La Ravoire (FR)

(72) Inventors: Jean-Philippe GRIS, La Ravoire (FR); Mohamed-Tahar RAHAL, Chambery (FR)

(73) Assignee: BOLLHOFF OTALU S.A., La Ravoire (FR)

(21) Appl. No.: 15/894,139

(22) Filed: Feb. 12, 2018

(30) Foreign Application Priority Data
Feb. 17, 2017 (FR) 1751319

(51) Int. Cl. F16B 37/06; B21K 1/70; C21D 9/00; C21D 8/00; C21D 6/00; C21D 1/26

(52) U.S. Cl. CPC F16B 37/065; B21K 1/702; C21D 1/26; C21D 8/005; C21D 6/005; C21D 9/0068

(57) ABSTRACT

Method for manufacturing a clinch nut, comprising:
cold forging a steel body including a weight percentage of carbon comprised between 0.15% and 0.25% inclusive to form a workpiece including a pliable section designed to deform into a crimping bead and a connection section,
applying a heat treatment to the workpiece, and
tapping the connection section to form an internal thread.

### BACKGROUND OF THE INVENTION

The invention relates to clinch nuts.

### State of the Art

Clinch nuts are assembly accessories which can be fitted blind in holes of a support, i.e. from one side of this support and without having access to the opposite side of the support.

A clinch nut comprises a hollow shank capped by a retaining head. A first section of this shank is designed to be folded into a bulged configuration when crimping is performed on completion of which this bulged configuration and the retaining head clamp a portion of the support between them, thereby ensuring axial securing of the clinch nut. A second section of the shank comprises a tapped hole into which a threaded rod can be screwed when assembly is performed.

Manufacturing of clinch nuts generally comprises forming of workpieces by cold forging of steel bodies, followed by heat treatment of these workpieces, called annealing, tapped holes then being made in these workpieces.

For certain applications where the nuts are subjected to high mechanical stresses, clinch nuts called “high-strength” clinch nuts are required. Manufacturing of the latter gives rise to a particular difficulty resulting from the necessity of obtaining a nut that provides a high tensile strength and that is sufficiently malleable to be able to fold without too much difficulty and without cracking in order to be able to be crimped onto a support.

European Patent EP 1462208 can be cited which describes a method for manufacturing a clinch nut. This method comprises formation of a workpiece by a first cold-heading operation of a raw steel metal part, heat treatment of the workpiece by annealing, followed by boring by a second cold-heading operation. The tapping operation is performed after the second cold-heading operation. This manufacturing method with two cold-heading operations is complex and costly as it requires two forging steps of the nut.

UK Patent application GB 2368889 proposes two methods for manufacturing clinch nuts.

In one of these two methods, an insert is partially cold forged from a steel with a low carbon content (containing 0.1% of carbon), after which only a portion of the insert is subjected to a localised annealing. An internal thread is then formed. The localised annealing step is however a step that is costly and complex to implement as it requires specific equipment.

In the other method presented in the Patent application GB 2368889, an insert is partially cold forged from a steel with a medium carbon content, having between 0.3% and 0.35% of carbon. The cold forging step is followed by annealing of the whole of the insert followed by tapping. This tapping does however then have to be hardened by a hardening step by localised induction at the level of the tapped area in order to enhance the strength of the nut.

### Object of the Invention

One object of the invention consists in palliating the above-mentioned shortcomings, and more particularly in providing a clinch nut having an enhanced mechanical strength.

Another object of the invention is to provide a simple method for manufacturing one such nut.

According to one feature of the invention, a method for manufacturing a clinch nut is proposed, comprising the following steps:
cold forging a steel body to form a workpiece comprising a pliable section designed to deform into a crimping bead, and a connection section,
applying a heat treatment to the workpiece, and
tapping the connection section to form an internal thread.

In this method, the steel body comprises a weight percentage of carbon comprised between 0.15% and 0.25% inclusive.

In this way, a clinch nut can be manufactured having one section which can deform without cracking and also comprising a tapped section providing an efficient mechanical tensile strength. Such a nut is made from a steel body with a low carbon content, i.e. a steel body comprising a carbon weight percentage comprised between 0.15% and 0.25% inclusive. In conventional manner, the low carbon nuts are hardened by performing a quenching step which consists in cooling the nut rapidly to increase its hardness. Not performing quenching on a low carbon steel part, in particular after annealing, therefore goes against common practice and is contrary to generally admitted knowledge in metallurgy, in particular when an increased strength is sought for.

Due to the annealing, the pliable section remains sufficiently resistant to breaking and sufficiently malleable or ductile to be able to fold into the bulged configuration, without requiring the use of excessively high forces and without the appearance of redhibitory defects such as cracks,

In parallel therewith, an improvement of the mechanical capacity of the nut in terms of maximum applicable load is obtained although the steel body selected undergoes an annealing operation without this annealing being followed by quenching

The steel body can comprise a weight percentage of manganese comprised between 0.9% and 1.2% inclusive and a weight percentage of boron comprised between 0.0008%and 0.0050% inclusive.

The heat treatment step can comprise a heating of the workpiece to a temperature comprised between 630° C. and 720° C. inclusive.

The heating of the workpiece can be performed at a temperature that is kept constant.

The heating of the workpiece can be performed for a time period comprised between 10 and 15 minutes.

The tapping step can comprise a creep without removal of material from an internal surface of the connection section.

According to another feature of the invention, a clinch nut is proposed comprising a pliable section designed to deform into a crimping bead, and a connection section comprising an internal thread.

The nut is made from steel comprising a weight percentage of carbon comprised between 0.15% and 0.25% inclusive.

The nut can comprise a weight percentage of manganese comprised between 0.9% and 1.2% inclusive and a weight percentage of boron comprised between 0.0008% and 0.0050% inclusive.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 is a mixed view of an embodiment of a clinch nut according to the invention, the left-hand half-view being in cross-section and the right-hand half-view being in perspective view,

FIG. 2 is a mixed view of the nut illustrated in FIG. 1 after fixing of the latter by crimping in a hole of a support plate,

FIG. 3 schematically illustrates the main steps of an embodiment of implementation of a method according to the invention,

FIG. 4 is a side view of a steel body designed to be cold forged,

FIG. 5 is a mixed view of an embodiment of a workpiece, and

FIG. 6 is a cross-sectional view of another embodiment of a nut.

### DETAILED DESCRIPTION

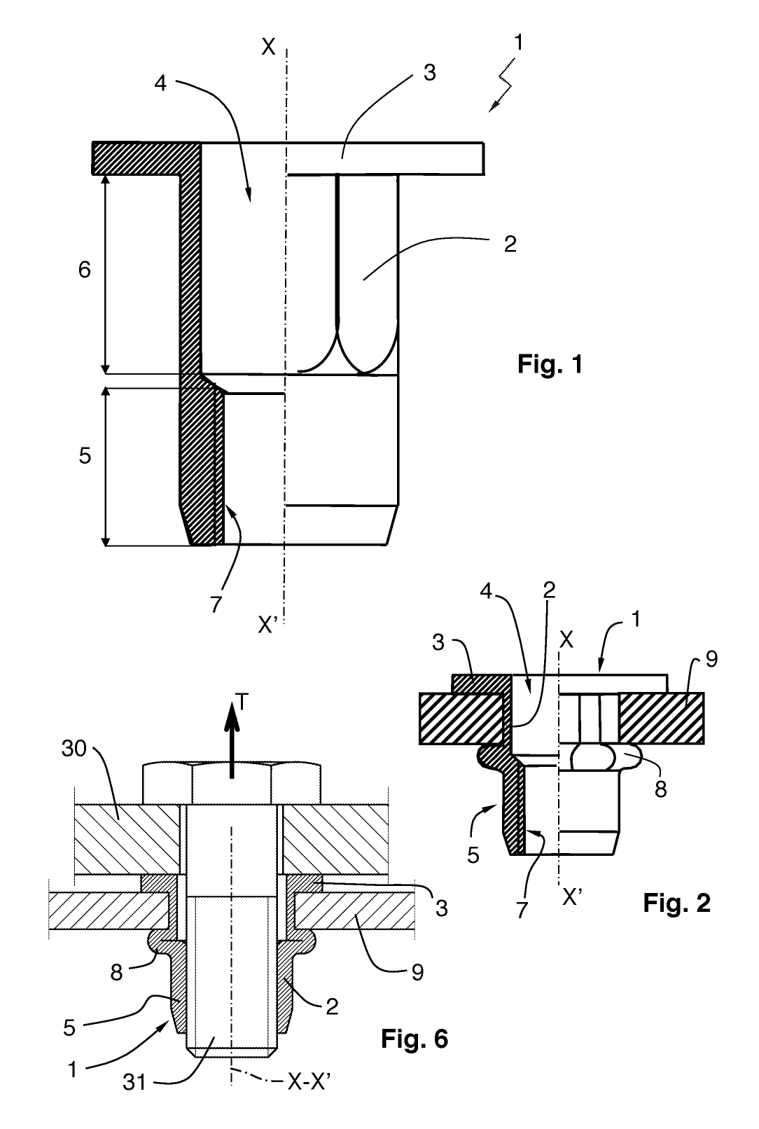

In FIG. 1, the reference numeral 1 designates a clinch nut according to the invention. This clinch nut 1 is formed by a single part. The clinch nut involved is advantageously able to be fitted in a blind manner.

The clinch nut 1 comprises a hollow shank 2 and an axial retaining head 3 which presents the form of an outer rim equipping one end of this hollow shank 2. The shank 2 and head 3 are advantageously coaxial, being centered on the same longitudinal axis X-X′. An axial hole 4 for passage of a rod extends through the head 3 and into the shank 2. In the example represented, the hole is a through hole. As an alternative, the axial hole 4 can be a blind hole.

The shank 2 comprises two sections axially offset from one another, viz. a tapped connection section 5 for anchoring a threaded rod by screw-fastening and a pliable section 6 which is located between the tapped section 5 and the head 3. At the level of its pliable section 6, the wall of the shank 2 is less thick than at the level of the connection section 5.

The tapped hole of the connection section 5 bears the reference numeral 7. This tapped hole 7 corresponds to an internal thread.

The pliable section 6 is sufficiently malleable to be able to contract by performing an accordion movement, folding onto itself, when the connection section 5 is pulled towards the head 3. When it folds, this pliable section 6 deforms to form a bulged configuration performing axial securing, noted crimping bead bearing the reference numeral 8 in FIG. 2, which illustrates the nut 1 after the latter has been crimped onto a support 9, for example a plate.

In FIG. 2, the bulged configuration 8 is an external annular bead in contact with the support 9. The bulged configuration 8 and head 3 axially clamp the support 9 between them.

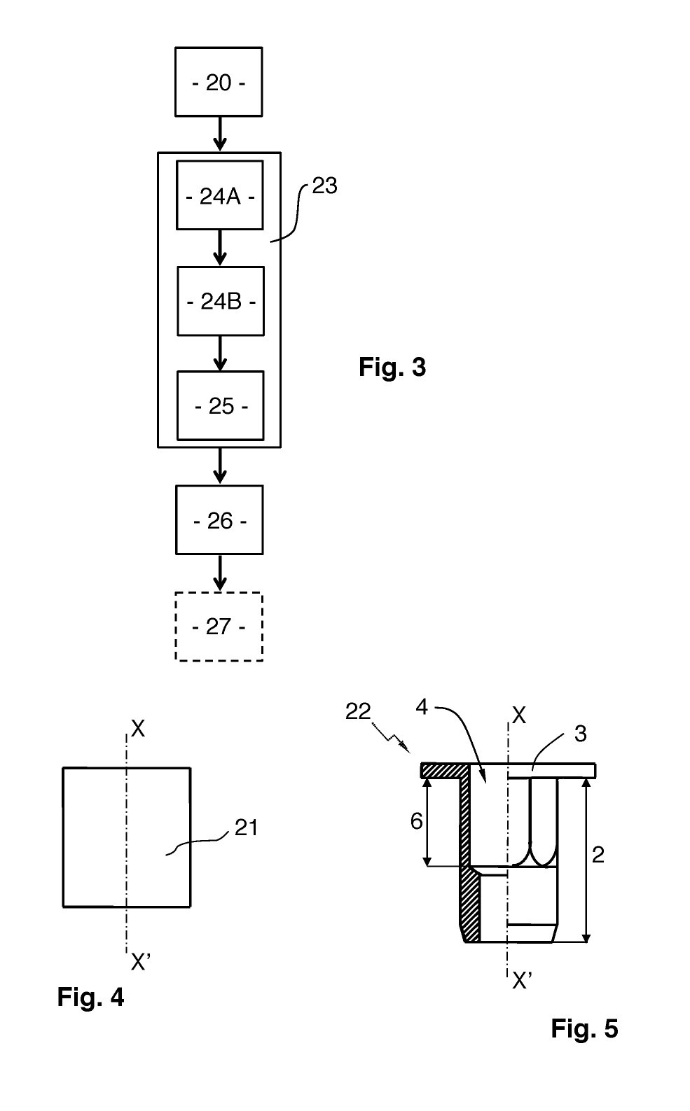

The method for manufacturing the clinch nut 1 comprises a succession of steps represented schematically by rectangles in FIG. 3. One of these steps is a cold forging 20 in which a steel mass in the state of a slug, noted steel body and bearing the reference numeral 21 in FIG. 4, is shaped to form a workpiece 22. This slug 21 is made from a cold-forgeable steel. More particularly, this steel comprises a carbon weight percentage comprised between 0.15% and 0.25% inclusive, and is a steel with a low carbon content. The slug 21 can also be made from steel comprising particular manganese and boron contents. Said particular contents, expressed in weight percentage, are the following:
manganese: between 0.9 and 1.2% inclusive, and boron: between 0.0008 and 0.0050% inclusive.

The weight percentage of a component is equal to one hundred times the weight fraction of the component. The weight fraction of a component is equal to the ratio of the weight of the component over the total weight of the slug 21.

17 MnB4, 20 MnB4 and 23 MnB4 steels present carbon, manganese and boron contents comprised in the ranges indicated above. In particular, these steels have the following contents expressed in weight percentage.

For 17 MnB4 steel:
carbon: between 0.15% and 0.20% inclusive;
manganese: between 0.9% and 1.2% inclusive; and boron: between 0.0008% and 0.0050%.

For 20 MnB4 steel:
carbon: between 0.18% and 0.23% inclusive;
manganese: between 0.9% and 1.2% inclusive; and
boron: between 0.0008% and 0.0050%.

For 23 MnB4 steel:
carbon: between 0.20% and 0.25% inclusive;
manganese: between 0.9% and 1.2% inclusive; and
boron: between 0.0008% and 0.0050%.

In the example described here, the steel of the slug 21 is more precisely 20 MnB4 steel. Having given good results, the use of 20 MnB4 steel is in fact advantageous.

The workpiece obtained by cold forging 20 is represented alone by the reference numeral 22 in FIG. 5. It forms a single part and has the same shape as the ready-to-use clinch nut 1, except for the fact that the tapped hole 7 is not yet present.

Cold forging 20 results in strain hardening of the slug 21 which, combined with the intrinsic properties of the latter, gives it a high strength and toughness. Strain hardening of the slug 21 affects certain mechanical properties of the steel, in particular those which have to enable the pliable section 6 to fold correctly into the bulged configuration 8 without redhibitory defects such as cracks appearing. The folding property is at least partially restored by means of heat treatment 23, also called annealing, which follows the cold forging 20. Preferentially, the annealing is applied to the whole of the workpiece 22 so that the method is simplified and more economical. Furthermore, the annealing 23 enables the hardness of the workpiece 22 to be reduced in order to obtain a pliable section 6 which is able to deform. Annealing 23 of the workpiece 22 does not require any specific equipment and can on the contrary be performed using a conventional furnace.

The annealing 23 is more precisely a recrystallization annealing by means of which the structure distorted and strain hardened by the cold forging 20 is replaced by a new structure with reformed grains. The recrystallization annealing 23 performed on the workpiece 22 reduces certain performances such as the tensile strength and hardness, but enables the structure of the workpiece 22 to be re-homogenised and gives it an increased coefficient of elongation necessary for the final function of the pliable section 6.

In a particular embodiment, annealing 23 is performed by means of a furnace which has been previously heated to an annealing temperature. The workpiece 22 is placed in this furnace which is already at the annealing temperature. Following this, heating 24A of the workpiece 22 takes place. This workpiece 22 is left in the furnace at a temperature kept substantially constant 24B, i.e. at the annealing temperature. The annealing temperature is comprised between 630° C. and 720° C. inclusive. More particularly, the annealing temperature is kept constant 24B during a time period comprised between 10 and 15 minutes. Maintaining 24B the workpiece 22 at the annealing temperature is terminated in substantially instantaneous manner by removing this workpiece 22 from the furnace. This removal from the furnace is followed by slow cooling 25 of the workpiece 22 in the open air and at ambient temperature, lower than the annealing temperature.

The annealing temperature and the time period of maintaining 24B at this annealing temperature are to be adjusted according to the steel used.

Annealing 23 is followed by a tapping operation 26 as illustrated in FIG. 3. Advantageously, the tapping operation 26 is tapping by creep without removal of material, otherwise known as tapping by deformation, in which the tapped hole 7 is formed by making the steel creep locally at the level of an internal surface of the connection section 5, and in which strain hardening thus takes place resulting in hardening of the material at the level of the tapped hole 7. Alternatively, the tapped hole 7 can be achieved by removal of material.

The clinch nut 1 obtained by means of the cold forging 20, of the annealing 23 and of the tapping operation 26 is compatible with an optional surface treatment 27. This surface treatment 27 can be an electrolytic deposition or projection of a corrosion protection coating, or immersion in a bath of corrosion protection coating agent. The surface treatment 27 can give the clinch nut 1 an electric insulation coating or an electric conduction coating, or a coating providing an aesthetic appearance. The coating provided by the surface treatment 27 can also be a sealing coating such as a screwing brake coating in the tapped hole 7.

The mechanical capacity of the clinch nut 1 obtained by means of the method defined in the foregoing is increased in terms of maximum applicable load. Furthermore, the pliable section 6 of the clinch nut 1 obtained is sufficiently malleable to be able to form the bulged configuration 8, after it has been axially compressed. This pliable section 6 folds without requiring the use of incommensurate forces and without the appearance of redhibitory defects such as cracks.

In FIG. 6, an assembly accessory comprises a clinch nut 1 obtained by means of the method defined in the foregoing. The clinch nut 1 has a tapped connection section 5 complementary to a threaded rod. It participates in assembling equipment 30 on a support 9 by means of a screw, bearing the reference numeral 31. the threaded rod of which is screwed into the connection section 5. Axial tensile tests on a head of the screw 31 in the direction of the arrow T, whereas the other components represented in FIG. 6 were secured in the opposite direction, showed that the securing of this screw 31 in the connection section 5 has a tensile strength greater than 60,300 N and more particularly greater than 67,300 N.

It was also observed that the head 3 of the clinch nut 1 presents the advantage of presenting an improved caulking resistance, i.e. a resistance to accidental displacement of material due to repeated shocks.

The steel of the clinch nut 1 is a steel comprising a weight percentage of carbon comprised between 0.15% and 0.25%. The nut 1 can also comprise a weight percentage of manganese comprised between 0.9% and 1.2% and a weight percentage of boron comprised between 0.0008% and 0.0050%.

The clinch nut according to the invention or obtained according to the method of the invention presents a particular crystalline microstructure compared with assembly accessories of the prior art. Indeed, the recrystallization annealing concerns the whole of the part, rather than being a localised annealing where the recrystallization area only concerns the pliable section.

1. A method for manufacturing a clinch nut, comprising:
cold forging a steel body to form a workpiece including a pliable section designed to deform into a crimping bead, and a connection section, the steel body comprising a weight percentage of carbon comprised between 0.15% and 0.25% inclusive,
heating of the workpiece at an annealing temperature comprised between 630° C. and 720° C. inclusive by means of a furnace which has been previously heated to the annealing temperature, and
tapping the connection section to form an internal thread

2. The method according to claim 1, wherein the steel body comprises a weight percentage of manganese comprised between 0.9% and 1.2% inclusive and a weight percentage of boron comprised between 0.0008% and 0.0050% inclusive.

3. The method according to claim 1, wherein the heating of the workpiece is performed at the annealing temperature that is kept constant.

4. The method according to claim 1, wherein the heating of the workpiece is performed for a time period comprised between 10 and 15 minutes.

5. The method according to claim 1, wherein the tapping comprises a creep without removal of material from an internal surface of the connection section.

6. A clinch nut, comprising a pliable section designed to deform into a crimping bead, and a connection section comprising an internal thread, the nut being made from steel comprising a weight percentage of carbon comprised between 0.15% and 0.25% inclusive, a weight percentage of manganese comprised between 0.9% and 1.2% inclusive and a weight percentage of boron comprised between 0.0008% and 0.0050% inclusive.
